(19) United States
(12) Patent Application Publication
(10) Pub. No.: US 2017/0038842 A1
(43) Pub. Date: Feb. 9, 2017

(54) SYSTEM FOR ENHANCING STYLUS FEEDBACK

(71) Applicant: Tactus Technology, Inc., Hayward, CA (US)

(72) Inventors: Micah Yairi, Fremont, CA (US); Justin Virgili, Fremont, CA (US)

(73) Assignee: Tactus Technology, Inc., Hayward, CA (US)

(21) Appl. No.: 15/227,726

(22) Filed: Aug. 3, 2016

Related U.S. Application Data
(60) Provisional application No. 62/200,231, filed on Aug. 3, 2015.

(51) Int. Cl. G06F 3/01; G06F 3/044; G06F 3/0354

(52) U.S. Cl. CPC G06F 3/016; G06F 3/03545; G06F 3/044

(57) ABSTRACT

A stylus feedback-enhancing film for a touchscreen that includes an optically clear stylus interface layer and an optically clear substrate layer, the substrate layer having a second hardness lesser than the first hardness and a second thickness greater than the first thickness; wherein the substrate layer is coupled to the stylus interface layer and the touchscreen; wherein the stylus-feedback enhancing film resists lateral motion of the stylus across the touchscreen with a first frictional force when the stylus is slid across the touchscreen with no applied force and with a second frictional force, greater than the first frictional force, when the stylus is slid across the touchscreen with an applied force consistent with human writing; wherein the first frictional force is dominated by the adhesive effect and the second frictional force is dominated by the plowing effect.

### CROSS-REFERENCE TO RELATED APPLICATIONS

This application claims the benefit of U.S. Provisional Application Ser. No. 62/200,231, filed on 3 Aug. 2015, which is incorporated in its entirety by this reference.

### TECHNICAL FIELD

This invention relates generally to the field of touch-sensitive interfaces, and more specifically to a system for enhancing stylus feedback for a computing device.

### BRIEF DESCRIPTION OF THE FIGURES

FIG. 1 is a cross-sectional representation of a system of an invention embodiment;

FIG. 2 is a cross-sectional representation of a film of a system of an invention embodiment;

FIG. 3 is a cross-sectional representation of a system of an invention embodiment;

FIG. 4A is a top-down representation of a system of an invention embodiment;

FIG. 4B is a cross-sectional representation of a system of an invention embodiment; and

FIG. 5 is a cross-sectional representation of a film of a system of an invention embodiment.

### DESCRIPTION OF THE PREFERRED EMBODIMENTS

The following description of the preferred embodiment of the invention is not intended to limit the invention to these preferred embodiments, but rather to enable any person skilled in the art to make and use this invention.

In the infancy of personal computing devices, stylus-based interfaces were commonplace. One of the first uses of stylus-based human interface was the light pen, which was used as early as 1955.

In addition to the role of the stylus in early computers, the stylus also played a pivotal role in the history of pocket computing devices; the vast majority of early personal digital assistants (PDAs) used styluses as input devices.

Unlike the original light pen (which suffered highly from accuracy and user fatigue issues), the styluses used with the resistive touch sensors of PDAs provided a relatively high degree of accuracy and input ease. Unfortunately, though, the GUIs powering stylus-based PDAs were clunky and overly based on desktop operating systems. This created an ecosystem ripe for disruption, and in 2007, the finger-centric design of the iPhone took advantage of the climate, leaving stylus-based PDAs in a cloud of plastic dust.

Of course, the mobile computing scene of 2016 barely resembles that of 2007, and the stylus has returned in style. Partly enabled by the increased resolution and performance of capacitive touchscreens (and styluses capable of interacting with them) and partly enabled by the emergence of the tablet market, consumers are increasingly demanding the fine precision and capability of interaction afforded only by the use of a stylus. Even Apple, with the introduction of the iPad Pro and Apple Pencil, has acknowledged this trend.

Unfortunately, the touch interfaces of modern computing devices still quite resemble those of previous finger-centric devices. Often hard, slick, and formed of glass or glasslike material, these interfaces provide a stylus experience incapable of providing the same high accuracy and feel that consumers could achieve with pen and paper.

Manufacturers have attempted to address this issue by making styluses with soft, deformable tips—a compromise that provides enhanced feel, but at a significant cost of durability and accuracy.

The present application is directed to a system for enhancing stylus feedback that provides stylus users with the feel of traditional writing without the accuracy tradeoffs taken by stylus manufacturers.

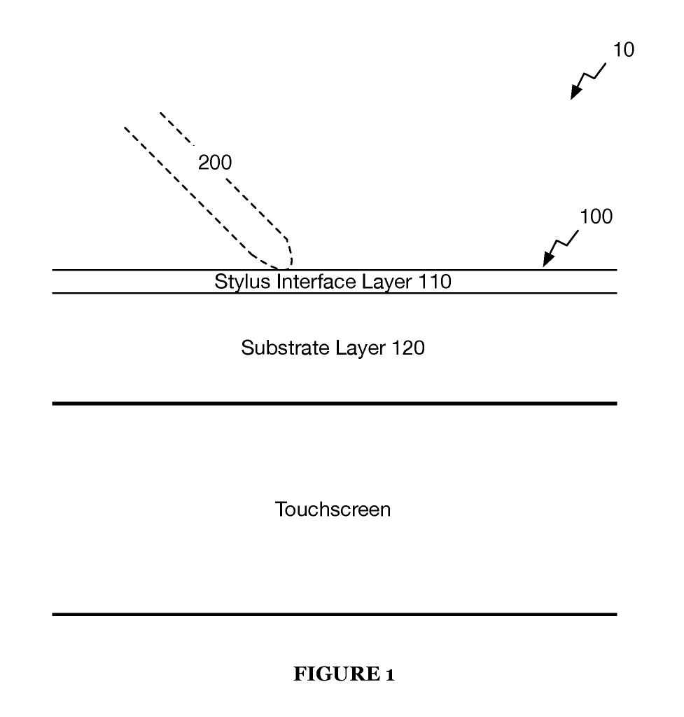

As shown in FIG. 1, a system 10 for enhancing stylus feedback includes a stylus feedback enhancing film 100. The system may additionally include a stylus 200.

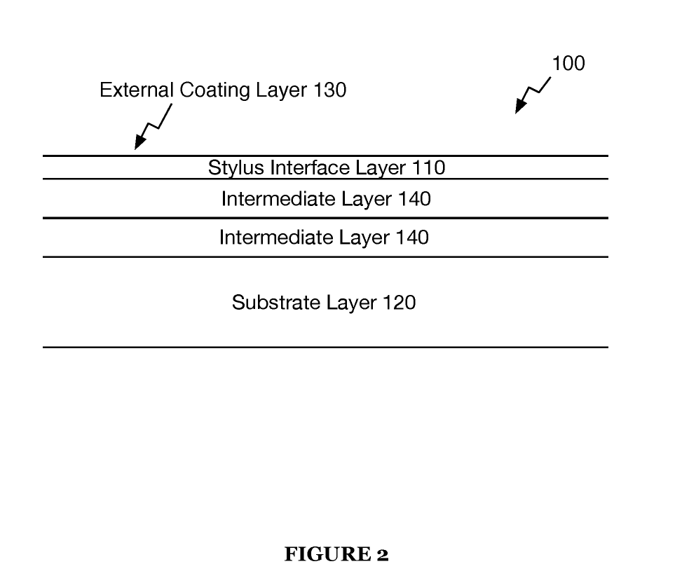

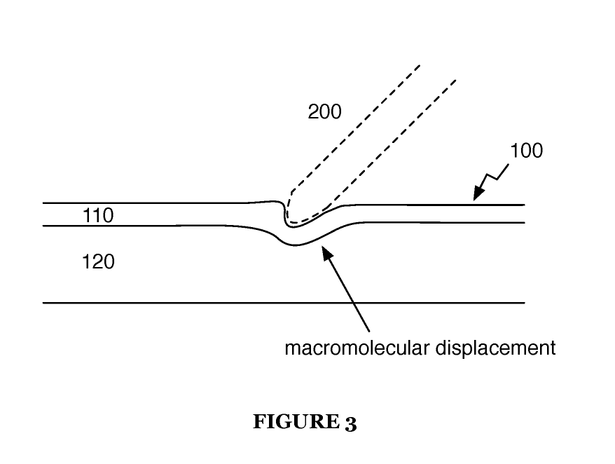

The stylus feedback enhancing film 100 preferably includes a stylus interface layer 110 and a substrate layer 120. The stylus enhancing film may additionally or alternatively include an external coating layer 130 and/or any number of intermediate layers 140, as shown in FIG. 2.

When a pen is applied to paper in the course of writing, the user writing relies heavily on the presence of feedback; that is, forces resisting the applied force of writing, to judge displacement of the pen in the course of writing. In other words, people can tell, without looking down, how far they have moved the pen (and even other characteristics, such as the width of the stroke or opacity of ink applied) based on the feel of the paper and knowledge of the pen. The complex and rich feedback experienced during the course of writing is the result of a complex blend of frictional forces resulting a combination of intermolecular adhesion between the pen/paper interface (the adhesive effect) and macromolecular material displacement (referred to as the plowing effect). The feedback is further enhanced by the feeling of deformation itself (i.e., the detectable indentation of the paper by the pen). In other words, the paper actually deforms around the pen, which provides a substantial contribution to the feel of writing. This result of this effect is apparent to anyone who has seen the indention made by heavy writing in paper or the consequences of attempting to write with a ballpoint pen on a hard surface.

Unfortunately, as previously mentioned, most modern touch interface and stylus systems have hard and non-deformable touchscreens. The response of such a system results in an inconsistent feel that makes it all but impossible to judge writing progress in any way approaching the tactile finesse of pen on paper. Of course, these touchscreens have their advantages—the same glass material that makes them slick, hard, and poorly suited for styluses also makes them excellent for viewing visual content and further lends to their durability in a way the softer screens of PDAs past never could match.

Via use of carefully selected materials and smart layer composition, the application of the stylus enhancing film 100 to touch-interface electronic devices enables styluses to preserve much of the high optical clarity and scratch resistance of glass touchscreens while providing a substantially enhanced writing feel, substantially increasing precision and accuracy of stylus-based interfacing. The film 100 may provide these advantages to any electronic device with a touch interface; e.g., capacitive touch sensor/touchscreen, resistive touch sensor/touchscreen, frustrated total internal reflection (FTIR) based touch sensor, displays with pressure sensors, etc.

The stylus feedback enhancing film 100 preferably provides these advantages through use of a relatively thin stylus interface layer 110 overlaid on top of a thicker substrate layer 120 (potentially separated by one or more intermediate layers 140). The stylus interface layer 110 is preferably resilient enough to provide scratch protection and a sufficiently slick surface for finger-centric interaction while still soft enough to deform elastically in response to applied writing force of a stylus. The thicker substrate layer 120 is preferably a softer layer underlying the stylus interface layer that deforms to a greater extent than the interface layer, providing the feedback required for a superior stylus-based interface experience. Both of the stylus interface layer 110 and substrate layer 120 comprise optically clear materials, preventing substantial absorption of light generated by the display of the electronic device the film 100 is applied to. Additionally or alternatively, any layers of the film 100 may have any thickness, hardness, or any degree of optical clarity. In one example, the stylus interface layer is between 1 micron and 100 microns thick and the substrate layer is between 50 microns and 200 microns thick. Likewise, the layers of the film 100 may have any other characteristics desired (e.g., the refractive indices of the layers may be close to each other to prevent reflection).

The stylus interface layer 110 preferably has a low coefficient of friction, enabling fingers to slide easily on the exterior of the layer 110 and preventing styluses from experiencing uneven movement that may result from stick-slip motion with the interface layer 110 material. This low-friction aspect of the layer 110 may be an inherent function of the material, but may additionally or alternatively result from surface treatment of the layer 110 (or application of the coating 130, described in later sections).

Together, the layers of the film 100 preferably deform elastically enough to provide feedback to a given stylus (noting that ideal values of the film 100 parameters described here may vary substantially for different stylus designs) without providing excessive friction or deforming plastically, while also preventing stick-slip motion of the stylus tip. The deformation described here may be characterized in a number of manners.

For instance, layer properties may be characterized by the Young's modulus of each layer; that is, the relationship between applied force and deformation. The layers of the film 100 preferably have a modulus low enough to enable the material to stretch noticeably in response to the typical forces applied by a stylus; e.g. 0.3N (corresponding to ˜30 g) to 3.5N (corresponding to ˜356 g).

As another example, layer properties may be characterized by shear modulus; a material's response to shear stress, related to the lateral compression or tension, or both. In particular, it may be desirable for layer materials to be slightly shear-thickening; i.e., material resists shear more when the shear rate increases. Alternatively, materials may be shear-thinning or shear-thickening by any degree.

Additionally or alternatively, layer properties may be characterized by compression set (the permanent deformation remaining when a compressive force that was applied to the surface is removed), tensile set, Shore hardness, strain hardening, and/or shear hardening.

In a first example of layer characterization, the film 100 is characterized by Shore hardness. In this example, the stylus interface layer 110 is preferably of a hardness of 80 Shore A to 75 Shore D, more preferably of a hardness of 85 Shore A to 65 Shore D, and most preferably of a hardness of 90 Shore A to 60 Shore D; while the substrate layer 120 is preferably of a hardness of 60 Shore A to 65 Shore D, more preferably of a hardness of 75 Shore A to 55 Shore D, and most preferably of a hardness of 80 Shore A to 50 Shore D. Further, the interface layer 110 is preferably of greater hardness than the substrate layer 120. Alternatively, the layers of the film 100 may be of any hardness.

In a second example of layer characterization, the film 100 is characterized by tensile strength at 50% strain (as measured according to ASTM D638 using a Type V sample geometry). In this example, the stylus interface layer 110 is preferably of a tensile strength of 5 to 15 MPa, more preferably of a tensile strength of 5 to 10 MPa, and most preferably of a tensile strength of 5 to 8 MPa; while the substrate layer 120 is preferably of a tensile strength of 1 to 10 MPa, more preferably of a tensile strength of 1 to 5 MPa, and most preferably of a tensile strength of 2 to 4 MPa. Further, the interface layer 110 is preferably of greater tensile strength than the substrate layer 120. Alternatively, the layers of the film 100 may be of any tensile strength.

In a third example of layer characterization, the film 100 is characterized by tensile set at 50% strain (as measured according to ASTM D638 using a Type V sample geometry). In this example, the stylus interface layer 110 is preferably of a tensile set of 0 to 25%, more preferably of a tensile set of 0 to 15%, and most preferably of a tensile set of 0 to 8%; while the substrate layer 120 is preferably of a tensile set of 0 to 20%, more preferably of a tensile set of 0 to 10%, and most preferably of a tensile set of 0 to 5%. Further, the interface layer 110 is preferably of greater tensile set than the substrate layer 120. Alternatively, the layers of the film 100 may be of any tensile set.

The system 10 may additionally or alternatively be characterized as a whole (or stated more generally, the film 100 may be characterized for a given stylus 200). For example, the film 100 may be characterized with respect to the dynamic scratch coefficient of friction (CoF) of a stylus having a 1.5 mm diameter polyoxymethylene (POM) trip applied with 300 g of force (˜2.9N). In this example, the film/stylus system preferably has a dynamic scratch CoF of 0.03 to 0.40, more preferably a dynamic scratch CoF of 0.05 to 0.25, and most preferably a dynamic scratch CoF of 0.07 to 0.15. Alternatively, a film 100/stylus 200 system may have a dynamic scratch CoF of any value.

As another example, the film 100 may be characterized by the actual distance of deformation (i.e., indentation). The film 100 may be characterized with respect to the indentation of a stylus with a rigid tip of 1.5 mm diameter applied with 300 g of force. In this example, the film 100 preferably indents between 10 and 200 microns in response to the applied force, more preferably indents between 15 and 100 microns in response to the applied force, and most preferably indents between 25 and 75 microns in response to the applied force. Alternatively a film 100/stylus 200 system may have indention of any magnitude for a given stylus and applied force.

These characterizations have been uniquely determined to result in a system 10 that provides substantially enhanced stylus feedback. The system 10 may be characterized in any manner to achieve a desired result (e.g., the feel of a ballpoint pen on heavyweight cotton paper).

The layers 110, 120, 130, and 140 may be fabricated in any manner from any materials to achieve desired film 100 or material properties. Examples of materials that may be used in the film 100 include urethanes, ureas, olefins, polyesters, plasticized polyvinyl chloride, polyesters (e.g., polyethylene terephthalate (PET) and/or polyethylene naphthalate (PEN)), polycarbonate, acrylic, silicones etc. Additionally, different types of urethanes may be used, such as those based on aromatic or aliphatic isocyantes and urethanes based on ether, ester, carbonate, or acrylic polyols. The materials chosen preferably have mechanical, optical, chemical or other properties (e.g. chemical resistance, stability under solar radiation, scratch resistance etc.) making them usable in the environmental conditions specific to an intended application. In one example, the stylus interface layer 110 includes self-healing material (e.g., self-healing urethane) that enable the layer 110 to be soft while still proving resistent to abrasion (thanks to the self-healing properties).

In one example, the film 100 may effect desired film properties by varying crosslinking present within the layers. When the degree of crosslinking is increased in materials, the flexibility may be affected, such as for example decreasing the flexibility or increasing flexibility, modulus, hardness and melting point of the material, and so on. Thus, by using different crosslink densities for different layers, the different layers may have a different flexibility and modulus and elasticity. In addition to cross-link density, the same type of variable mechanical property gradient can be achieved by varying the amount of an inorganic filler such as nanoparticles, nanorods, etc. A high filler content may correspond to a high modulus, etc.

Cross-linking and/or filler variance (any other aspect of the composition of layer material) may be varied according to any function (e.g., linearly with depth, exponentially with depth) to achieve a desired result. Cross-linking variation may be achieved in a number of manners, including chemically (e.g., via diffusion of a material promoting cross-linking), optically (e.g., via exposure to UV light), and/or thermally (e.g., via exposure of the material to a thermal gradient).

Similar strategies to those used to vary crosslink density may additionally or alternatively be used to generate layers with customized shear properties (e.g., by varying the amount of curing agent present in a polymer as a function of depth).

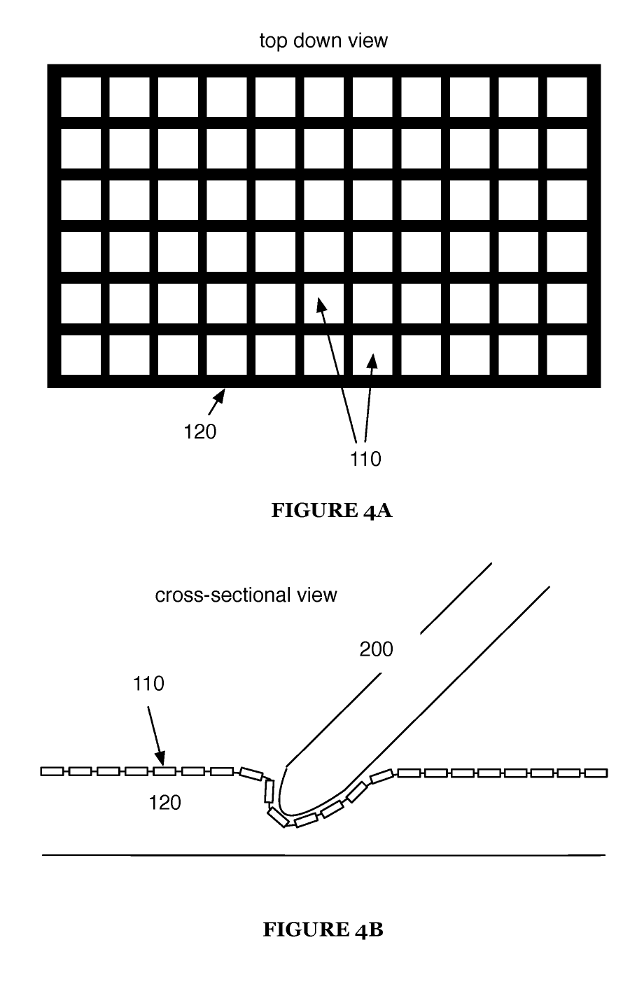

In addition to chemical or compositional variance, properties of the film 100 may be varied structurally in any manner to achieve desired results. In one example, the stylus interface layer 110 is spatially patterned to result in thinner film areas or even in film discontinuities, as shown in FIGS. 4A and 4B. This may allow for the use of substantially harder materials in the stylus interface layer 110 while still allowing substantial deformability. If the stylus interface layer 110 is divided into sub-sections, they are preferably small enough to enable deformation around the contour of a stylus tip (e.g., <1 mm̂2). Likewise, the gap between sections is preferably large enough to enable deformation, but small enough to not have a substantial effect on friction (e.g., due to the stylus running over ridges); for example, 10-100 microns. The stylus interface layer 110 (or any other layer of the film 100 may be patterned, divided, shaped, or otherwise structured in any manner.

The layers of the film 100 may be adhered or otherwise coupled to each other in any manner (e.g., chemically, mechanically, thermally, via an adhesive). Examples of adhesives that may be used in the film 100 may include an optically clear polyurethane, silicone, or acrylic solvent-based pressure-sensitive adhesive, but may additionally or alternatively be formed of any adhesive suitable for a permanent or non-permanent application of the film 100 to a surface.

Further, the substrate layer 120 may be adhered to the touchscreen (or other surface) of a touch sensor of an electronic device in any manner (e.g., mechanically, thermally, via an adhesive). If an adhesive is used, the adhesive is preferably applied directly to the substrate layer 120/device interface without an intermediate layer (e.g., an adhesion promoter), but may additionally or alternatively be applied with aid of an adhesion promoter or any other intermediary layer. The substrate layer 120 may fixed, removably fixed, or coupled to the device in any manner.

The external coating layer 130 is coupled to the surface of the stylus interface layer (if present) and may perform a number of functions. In one example, the external coating layer 130 is oleophobic (good for displays used by styluses and fingers both). In another example, the external coating layer 130 is an anti-reflection (AR) layer. In this example, the layer 130 may perform anti-reflection duties in any manner; e.g. index matching between air and the stylus interface layer 110. Alternatively, the external coating layer 130 may include one or more interference AR coatings (e.g., a single quarter-wavelength transparent layer, or a multi-layer interference stack). The external coating layer 130 may additionally or alternatively serve to modify frictional and/or durability characteristics of the stylus interface layer 110 in any manner.

The external coating layer 130 may be fabricated in any manner (e.g., deposition of nanoparticles, spray coating, atomic layer deposition (ALD), sputtering, etc.).

The intermediate layers 140 are preferably substantially similar in function to the other layers of the film 100 and may be designed in any manner applicable to the stylus interface layer 110 and substrate layer 120 as previously described. For example, if it is desired for a material property to be varied as a function of depth (e.g., the direction of the layer stack), each intermediate layer 140 may serve as an intermediate step between the beginning and end values at the layers 110 and 120.

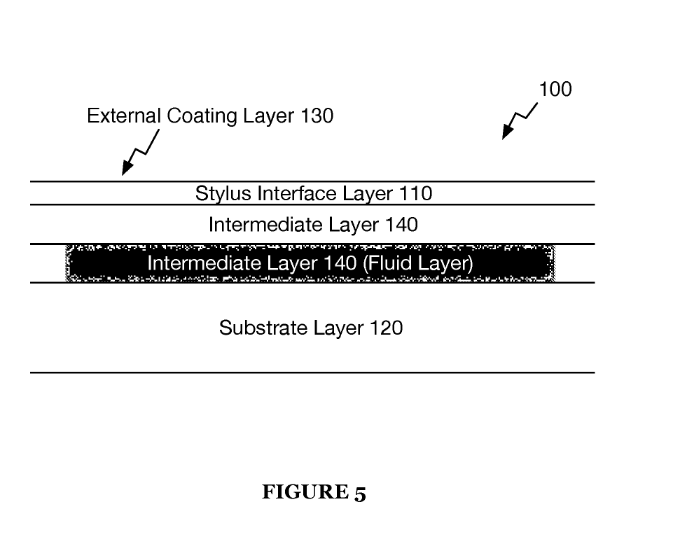

In a variation of an invention embodiment, one or more layers of the film 100 is filled with a fluid (e.g., liquid, gel, gas), as shown in FIG. 5. In the layer containing the fluid, the fluid is preferably contained by a solid boundary. Similar to the properties of the solid layers described previously, the structure and material properties of the fluid-containing layer may be tuned to achieve a desired writing feel. In some instances, fluid or gel may be dynamically pushed in or out of the layer. This may be performed using a slide or other mechanism that engages a bladder or other fluid-holding mechanism to force fluid out of the bladder, through a fluid channel and into the material stack layer. This allows the user to customize the feel for the material when using a stylus. Similarly, the slide may be used to withdraw fluid from the material stack layer and into the fluid bladder.

In a second variation of an invention embodiment, one or more layers of the film 100 may include integrated heating elements. For example, a user may indicate a stylus is being used (or perhaps the system self-identifies this by the small size of the stylus' interaction with the touch sensor), and the system then raises the temperature slightly so that the material feels better for stylus use. For example, silver nanowires may be effectively used as touch sensor transparent, extensible heating electrodes. When not heated, the material becomes more rigid, and more similar to standard displays or hard surfaces.

In a third variation of an invention embodiment, one or more layers of the film 100 includes materials with electrically and/or thermally variable material parameters (e.g., electroactive polymers that exhibit changes in shape, size, strain, stress, etc.). In this variation, the parameters of the film 100 may be altered to account for different stylus use, different writing styles, different environmental characteristics, etc.

The stylus 200 of the system may be any stylus capable of interacting with a touch sensor. For example, the stylus 200 may be a pen-shaped element constructed of plastic, metal, ceramic, or some other material that may be used as an input device to touch the surface of the computing device interface. The stylus 200 may be designed to interface with any type of touch interface (e.g., capacitive, resistive, FTIR). The stylus 200 preferably has a rigid tip (e.g., made of polyoxymethylene) but may additionally or alternatively have any type of tip.

As a person skilled in the art will recognize from the previous detailed description and from the figures and claims, modifications and changes can be made to the preferred embodiments of the invention without departing from the scope of this invention defined in the following claims.

What is claimed is:

1. A stylus feedback-enhancing film for a touchscreen, the film comprising:
an optically clear stylus interface layer, comprising a first shear-thickening urethane polymer, the stylus interface layer having a first Shore hardness, a first thickness, and a first tensile strength at 50% strain; wherein the first Shore hardness is between 90 Shore A and 60 Shore D; wherein the first tensile strength is between 5-8 MPa;
an optically clear substrate layer, comprising a second shear-thickening urethane polymer, the substrate layer having a second Shore hardness lesser than the first hardness, a second thickness greater than the first thickness, and a second tensile strength at 50% strain less than the first tensile strength; wherein the second Shore hardness is between 80 Shore A and 50 Shore D; wherein the second tensile strength is between 2-4 MPa; wherein the substrate layer is coupled to the stylus interface layer on a first side of the substrate layer and coupled to the touchscreen on a second side of the substrate layer;
wherein the stylus-feedback enhancing film enhances writing feedback via application of a force resisting lateral motion of the stylus across the film; wherein the force results from elastic deformation of the film during writing using the stylus.

2. The film of claim 1, wherein the stylus interface layer has a first tensile set at 50% strain; wherein the substrate layer has a second tensile set at 50% strain lesser than the first tensile set; wherein the first tensile set is between 0 and 8%; wherein the second tensile set is between 0 and 5%; wherein the first and second tensile sets are measured according to ASTM D638 using a type V sample geometry.

3. The film of claim 2, wherein the first shear-thickening urethane polymer is a self-healing polymer.

4. The film of claim 3, wherein the film further comprises an oleophobic coating applied to the stylus interface layer; wherein the oleophobic coating is between 1 nm and 500 nm in thickness.

5. A stylus feedback-enhancing film for a touchscreen, the film comprising:
an optically clear stylus interface layer, comprising a first shear-thickening polymer, the stylus interface layer having a first hardness and a first thickness;
an optically clear substrate layer, comprising a second shear-thickening polymer, the substrate layer having a second hardness lesser than the first hardness and a second thickness greater than the first thickness; wherein the substrate layer is coupled to the stylus interface layer on a first side of the substrate layer and coupled to the touchscreen on a second side of the substrate layer;
wherein the stylus-feedback enhancing film resists lateral motion of the stylus across the touchscreen with a first frictional force when the stylus is slid across the touchscreen with no applied force and with a second frictional force, greater than the first frictional force, when the stylus is slid across the touchscreen with an applied force consistent with human writing; wherein the first frictional force is dominated by the adhesive effect and the second frictional force is dominated by the plowing effect.

6. The film of claim 5, wherein both of the stylus interface layer and the substrate layer elastically deform in response to application by the stylus of the applied force consistent with human writing.

7. The film of claim 6, wherein the applied force consistent with human writing is between 0.1 Newton and 3.0 Newton.

8. The film of claim 6, wherein the first shear thickening polymer is a first urethane polymer and the second shear thickening polymer is a second urethane polymer.

9. The film of claim 6, wherein the stylus interface layer is between 1 micron and 100 microns thick; wherein the substrate layer is between 50 microns and 200 microns thick.

10. The film of claim 6, wherein the stylus interface layer has a first Shore hardness; wherein the substrate layer has a second Shore hardness lesser than the first Shore hardness; wherein the first Shore hardness is between 80 Shore A and 75 Shore D; wherein the second Shore hardness is between 60 Shore A and 65 Shore D.

11. The film of claim 10, wherein the first Shore hardness is between 90 Shore A and 60 Shore D; wherein the second Shore hardness is between 80 Shore A and 50 Shore D.

12. The film of claim 6, wherein the stylus interface layer has a first tensile strength at 50% strain; wherein the substrate layer has a second tensile strength at 50% strain lesser than the first tensile strength; wherein the first tensile strength is between 5 MPa and 15 MPa; wherein the second tensile strength is between 1 MPa and 10 MPa.

13. The film of claim 12, wherein the first tensile strength is between 5 MPa and 8 MPa; wherein the second tensile strength is between 2 MPa and 4 MPa; wherein the first and second tensile strengths are measured according to ASTM D638 using a type V sample geometry.

14. The film of claim 6, wherein the stylus interface layer has a first tensile set at 50% strain; wherein the substrate layer has a second tensile set at 50% strain lesser than the first tensile set; wherein the first tensile set is between 0 and 25%; wherein the second tensile set is between 0 and 20%.

15. The film of claim 14, wherein the first tensile set is between 0 and 8%; wherein the second tensile set is between 0 and 5%; wherein the first and second tensile sets are measured according to ASTM D638 using a type V sample geometry.

16. The film of claim 6; wherein the substrate layer is a continuous layer; wherein the stylus interface layer is composed of a set of multiple discontinuous regions.

17. The film of claim 16, wherein each of the set of discontinuous regions has an area of 1 square millimeter or smaller; wherein each of the set of discontinuous regions is separated from a closest next discontinuous region by a distance of 10 microns.

18. The film of claim 6; wherein the stylus interface layer has a first index of refraction at a visible wavelength; wherein the substrate layer has a second index of refraction at the visible wavelength; wherein the second index of refraction is within ten percent of the first index of refraction.

19. A system for enhancing writing feedback comprising a stylus feedback-enhancing film for a capacitive touchscreen and a stylus;
the stylus feedback-enhancing film comprising:
an optically clear stylus interface layer, comprising a first shear-thickening polymer, the stylus interface layer having a first hardness and a first thickness;
an optically clear substrate layer, comprising a second shear-thickening polymer, the substrate layer having a second hardness lesser than the first hardness and a second thickness greater than the first thickness; wherein the substrate layer is coupled to the stylus interface layer on a first side of the substrate layer and coupled to the touchscreen on a second side of the substrate layer;
the stylus comprising a stylus capable of registering motion on the capacitive touchscreen and having a hard polymer stylus tip;
wherein the stylus-feedback enhancing film enhances writing feedback via application of a force resisting lateral motion of the stylus across the film; wherein the force results from elastic deformation of the film during writing using the stylus.

20. The system of claim 19, wherein the stylus feedback-enhancing film and the stylus are configured to mimic feedback of a ballpoint pen writing on cotton paper.

21. The system of claim 19, wherein the stylus feedback-enhancing film and stylus together have a dynamic scratch coefficient of friction between 0.03 and 0.40; wherein the stylus has a polyoxymethylene tip 1.5 mm in diameter; wherein the dynamic scratch coefficient of friction is measured using 300 g of applied force.

22. The system of claim 21, wherein the stylus feedback-enhancing film and stylus together have a dynamic scratch coefficient of friction between 0.07 and 0.15.

23. The system of claim 19, wherein the stylus feedback-enhancing film deforms between 10 and 200 microns in response to an application of 300 g of applied force by the stylus; wherein the stylus has a rigid tip 1.5 mm in diameter.

24. The system of claim 23, wherein the stylus feedback-enhancing film deforms between 25 and 75 microns in response to an application of 300 g of applied force by the stylus.
